(19) United States
(12) Patent Application Publication
(10) Pub. No.: US 2009/0126830 A1
(43) Pub. Date: May 21, 2009

(54) PORTABLE SYSTEM FOR RECONDITIONING USED BARRELS

(76) Inventor: BRECK WATERMAN, KESWICK (AU)

Correspondence Address: Irving M. Weiner;Weiner & Burt, P.C., 635 N. US-23, P.O. Box 186, Harrisville, MI, 48740, US

(21) Appl. No.: 12/270,833

(22) Filed: Nov. 13, 2008

(30) Foreign Application Priority Data
Nov. 15, 2007 (AU) 2007234546

(51) Int. Cl. B27H 5/00

(52) U.S. Cl. 147/1

(57) ABSTRACT

The present invention relates to a portable system for reconditioning used barrels, in particular used wine barrels. The present inventor has realised a need in the wine industry for a portable system of reconditioning barrels which would provide a vineyard owner, for example, with the ability to have used barrels reconditioned within a day or two on site, as opposed to weeks or longer in the case of barrels transported to and from a cooperage facility. What is disclosed is a mobile barrel reconditioning system including at least a portable shaving apparatus to uniformly shave a predetermined depth of material from an internal surface of said barrel to thereby form a new internal surface, and a portable toasting apparatus to recondition said new internal surface ready for re-use. In a preferred form of the invention, the system includes a portable crozing apparatus.

The present invention relates to used barrel reconditioning and, in particular, to a portable reconditioning system involving shaving the inside of the used barrels, crozing the barrels, and toasting the shaved surface.

### BACKGROUND OF THE INVENTION

Wine is traditionally aged in oak barrels. The oak is integral to aging and imparting certain flavours to the wines. Wine fermenting and aging in wood barrels extracts flavour components from the wood and leaves a residue of precipitated materials such as tartrates, fining agents or yeast. Further, wine processing often leaves undesirable bacterial infections in the barrels for which there is no current remedy.

Wine typically penetrates into a solid barrel stave approximately 0.5 centimetres per use with alcohol penetrating even deeper to some 8 to 10 mm. Over time (typically after two to three uses), all components which can be extracted from the oak will be, and the residue left in the wood can begin to sour or block the membrane exchangeability of the wood. The barrel is then considered exhausted and is viewed either as a liability because of contamination, or as neutral storage for additional vintages.

Current reconditioning methods involve either transporting used barrels from vineyards to cooperage plants or doing it on site where the internal surfaces of the barrels are shaved and then toasted for re-use. Current methods of barrel shaving vary from simple hand held cutting routers and wire brushes, to more complex apparatus such as motorised cutting apparatus. There are also a number of different toasting techniques. Typically, the toasting process involves placing a barrel over a heat source, generally a furnace, for a particular length of time. The heat source applied to the interior surface of the barrel alters the chemical composition of the oak wood, bringing out different flavours and aromas. Different compounds are released or increased in concentration within the wood depending on whether these compounds were initially found in the wood and the toasting intensity and duration.

The applicant is the owner of a number of co-pending patent applications directed to barrel shaving, toasting and crozing apparatus and methods. The contents of these co-pending applications are incorporated by reference herein.

It is time consuming and expensive to have used barrels transported from a vineyard to a cooperage plant for reconditioning, and then to have them transported back to the vineyard for use. This problem is exacerbated when a cooperage is located long distances away from a vineyard, which is the case more often than not. The present inventor has realised a need in the wine industry for a portable system of reconditioning barrels which would provide a vineyard owner, for example, with the ability to have used barrels reconditioned within a day or two on site, as opposed to weeks or longer in the case of barrels transported to and from a cooperage facility.

It is therefore an object of the present invention to overcome this problem or to at least provide the public with a useful alternative.

### SUMMARY OF THE INVENTION

Therefore in one form of the invention there is proposed a system for reconditioning used barrels, said system including:

a portable means of shaving a predetermined amount of material from an internal surface of the used barrel to form a new inside surface;
a portable means of crozing at least one of said barrel ends; and
a portable means of toasting said new inside surface.

The present invention therefore provides for a barrel reconditioning system that may be transported within a mobile vehicle to winemaking facilities, for example, so that used barrels can be reconditioned on site.

Preferably said portable means of shaving said internal surface includes a scanning means adapted to scan the internal dimensions of the barrel, and a cutting means adapted to shave the internal surface of the barrel to a predetermined depth relative to the scanned internal dimensions.

Preferably said scanning means is adapted to vertically traverse the inside surface of the barrel to thereby scan a portion thereof with each pass.

In preference said cutting means is adapted to vertically traverse the inside surface of the barrel to thereby shave a portion thereof with each pass.

In preference movement of said scanning and cutting means relative to the inside surface of the barrel is controlled using a control means.

Preferably said apparatus includes a computing device into which at least one movement parameter for the scanning means is input and subsequently processed to form a first set of movement data to be communicated to the control means.

In preference said scanning means is further rotatable about a vertical axis, whereby said at least one movement parameter includes a scanning means start angle.

Preferably said at least one movement parameter includes a stop angle for the scanning means.

In preference said scanning means is pivotable about a horizontal axis, said at least one movement parameter thereby including the pitch of said scanning means.

In preference at least one movement parameter for the cutting means can also be input into said computing device and subsequently processed, together with dimensional data from the scanning means, to form a second set of movement data to be communicated to the control means.

Preferably said cutting means is further rotatable about a vertical axis, whereby said at least one movement parameter includes a cutting means start angle.

Preferably said at least one movement parameter includes a stop angle for the cutting means.

Preferably said cutting means is pivotable about a horizontal axis, said at least one movement parameter thereby including the pitch of said cutting means.

Preferably said at least one movement parameter includes a cut depth for each vertical pass of the cutting means.

Preferably said movement parameters include cut depth for a first pass of the cutting means and a cut depth for a second pass of the cutting means.

In preference said cutting means is in the form of an electrically driven router mounted to the end of a robotic arm capable of a range of controlled movements inside the barrel.

Advantageously said scanning means is in the form of a laser scanner suspended beneath said electrically driven router and moveable therewith.

Advantageously said robotic arm is pneumatically operated. However in some applications it could be operated by other means such as belt operated.

Preferably said robotic arm is mounted above a supporting table including an adjustable barrel mounting means associated therewith.

In preference said adjustable barrel mounting means is in the form of a sub-frame to which said barrel is attachable, said sub-frame being vertically moveably between a first position in which said attached barrel is grounded and a second position in which the attached barrel is ready to undergo shaving by said robotic arm.

In preference said sub-frame is moveable by a pneumatic cylinder.

Preferably said portable means of crozing said barrel includes:

a mounting means for securing said crozer to an end of said barrel; and
at least a first cutting means rotatably associated with said mounting means, said cutting means configured to form a groove along an inside surface of said barrel adjacent the end, said groove adapted to accommodate a barrel head.

Preferably said crozer includes a second cutting means rotatably associated with said mounting means, said second cutting means configured to form an inwardly extending bevel along an edge of the barrel end.

In preference said first and second cutting means are mounted to a supporting frame which rotatably engages the crozer mounting means, said first and second cutting means extending at least partially inside the barrel.

In preference said mounting means is in the form of an annular clamp adapted to engage an outer surface of an upright barrel adjacent an upper end thereof, such that said clamp sits substantially horizontally on the barrel.

In preference said annular clamp includes an annular guide disposed thereabove, said annular guide extending in a parallel arrangement with said clamp.

Preferably said supporting frame includes a plurality of radially disposed rollers adapted to slideably engage the annular guide.

Preferably the upright barrel includes a central vertical axis and said first cutting means is in the form of a pointed blade extending outwardly therefrom.

Preferably the horizontal and vertical position of said pointed blade is adjustable to thereby allow for the height and depth of the internal groove to be selected.

Preferably the horizontal position of the outwardly extending pointed blade is adjustable by rotation of a spindle having a shaft associated therewith in threaded engagement with a moveable sub-frame which supports said pointed blade.

In preference said sub-frame also supports a driving means for the pointed blade.

In preference said driving means is an electric motor.

Preferably said second cutting means is in the form of a downwardly extending router which when brought into contact with the inside edge of the barrel end, forms said bevel.

Preferably the horizontal and vertical position of said router is adjustable.

In preference said router is powered by an electric motor.

Preferably said portable means of toasting said new inside surface includes a heating means configured to be insertable and removable from inside said barrel, and a means of rotatably oscillating said heating means by a predetermined angle to facilitate uniform heating of said inside surface.

Preferably said heating means is in the form of a plurality of elongate vertical heating elements radially disposed about a central vertical axis.

In preference the temperature of heat delivered by each heating element is controllable.

Preferably each heating element is separated by an equal radial angle.

Preferably said predetermined angle of rotation corresponds with said equal radial angle by which said heating elements are separated.

In preference wherein said apparatus includes six parallel heating elements separated by a radial angle of sixty degrees.

Preferably each heating element is housed between end portions of a frame associated therewith.

Preferably said frame is configured to direct heat from said heating element to a predetermined radial area of said barrel inside surface.

Preferably said frame includes a portion having a substantially V-shaped cross section which extends behind said heating element whereby an apex thereof is directed toward the central vertical axis.

In preference an inside surface of said V-shaped frame portion is reflective to intensify the heat delivered by said heating elements.

In preference each frame is fixed between upper and lower co-axial circular plates, said lower plate being rotatable about a base plate adapted to be fixed to the ground during operation.

Preferably each heating element is of a length corresponding with the height of said barrel.

Preferably said beating means is in the form of an infrared heater.

In a further form of the invention there is proposed a mobile barrel reconditioning system including:

a portable shaving apparatus to uniformly shave a predetermined depth of material from an internal surface of said barrel and thereby form a new barrel internal surface; and
a portable toasting apparatus to recondition said new barrel internal surface ready for re-use.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 illustrates a side view and a cross sectional view of a used wine barrel that requires reconditioning;

FIG. 2 illustrates a portable system for reconditioning used barrels in accordance with an embodiment of the present invention;

FIG. 3 illustrates a perspective view of a shaving apparatus forming part of the system shown in FIG. 2 performing a scan of the inside surface of the barrel;

FIG. 4 illustrates a perspective view of the shaving apparatus of FIG. 3 shaving the inside surface of the barrel;

FIG. 5a illustrates an enlarged perspective view of a router assembly forming part of the apparatus of FIG. 3 and FIG. 4, when the laser shutter is open and ready for scanning;

FIG. 5b illustrates an enlarged perspective view of the router assembly of FIG. 5a when the laser cover is closed and the assembly is ready for cutting;

FIG. 6 illustrates a perspective view of a portable crozer forming part of the barrel reconditioning system shown in FIG. 2;

FIG. 7 illustrates of the portable crozer of FIG. 6 when mounted above a wine barrel;

FIG. 8 illustrates a side cross sectional view of the portable crozer and barrel of FIG. 7;

FIG. 9 illustrates a perspective view of a toasting apparatus forming part of the barrel reconditioning system shown in FIG. 2;

FIG. 10 illustrates a perspective view of the toasting apparatus of FIG. 9 after being lowered inside the barrel ready for use; and

FIG. 11 illustrates a top view of the oscillatory motion of the infrared heating elements forming part of the toasting apparatus of FIG. 10 and FIG. 11.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

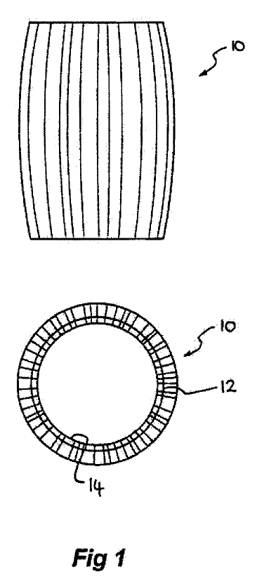

The present invention relates to reconditioning of used wine barrels. FIG. 1 illustrates a used barrel 10 which requires reconditioning. Line 12 in the cross-sectional view of the barrel 10 signifies the extent to which the internal surface 14 of the barrel 10 is to be shaved down so that is ready for re-crozing and toasting. The extent to which the surface is shaved is typically in the order of some 0.5-0.8 centimetres.

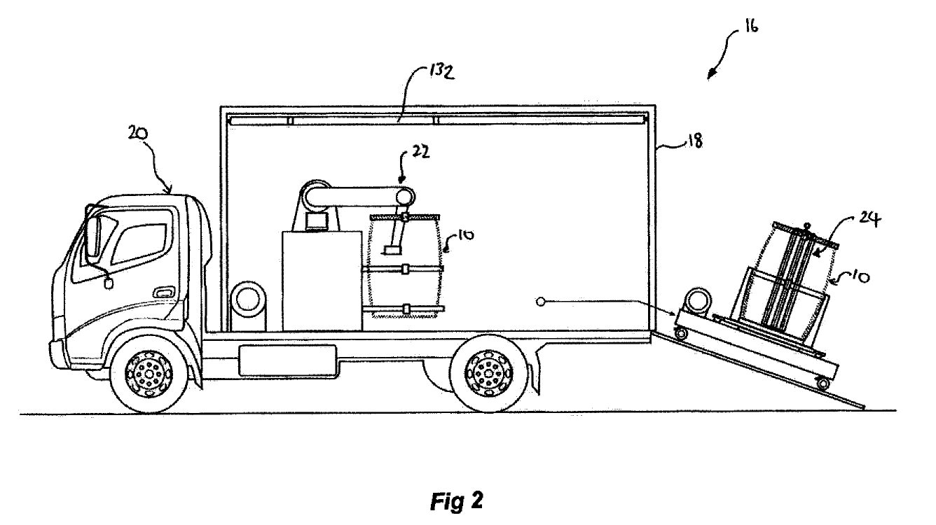

FIG. 2 illustrates a barrel reconditioning system 16 in accordance with one embodiment of the present invention, in particular, whereby the system 16 is housed within a carriage 18 of a truck 20. It is to be understood that other means of transporting the system 16 could equally well be used, such as a trailer or utility vehicle (not shown). The system 16 comprises a barrel shaving apparatus 22, a portable barrel crozer (not shown in FIG. 2), and a barrel toasting apparatus 24, all of which are described below. The toasting apparatus 24 is shown being wheeled out of the truck carriage 18 from its rest position. When the truck 20 arrives at a vineyard or other site, the various apparatus could be wheeled out as shown, or the vehicle could be configured to house all the apparatus during use. The preferred option would be to have the apparatus all housed inside the vehicle.

As mentioned in the preamble of the invention, the benefit of the present invention is that the system 16 can be transported to vineyards and winemaking facilities to completely recondition used barrels for reuse, rather than having used wine barrels transported to and from cooperage plants for reconditioning.

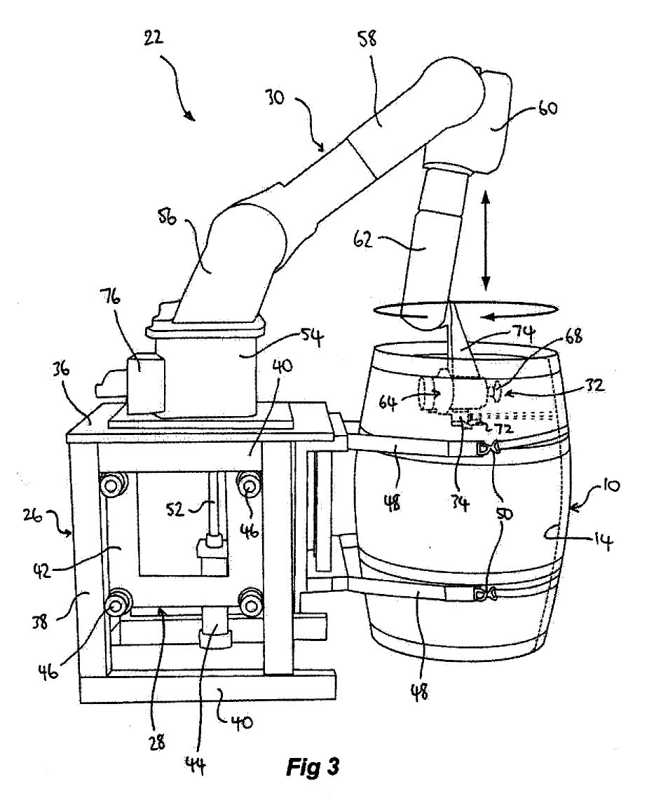

FIGS. 3-5 illustrate the preferred shaving apparatus 22 of the present invention. It is however to be understood that any suitable shaving apparatus could be used which is mobile and capable of performing a quick and controlled cut of the inside surface of the barrel.

The apparatus 22 comprises a base frame 26 having a height adjustable barrel mounting means 28 associated therewith, a robotic arm 30 mounted above the base frame 26, and a router assembly 32 positioned at the free end of the robotic arm 30, the router assembly 32 including a laser 34 suspended therefrom. The robotic arm 30 is capable of a range of controlled movements. In brief, the router assembly 32 and laser 34 are adapted to be controllably moved along the inside surface 14 of the barrel 10 to:

1) scan the internal dimensions of the barrel using the laser 34; and

2) shave the inside surface to a predetermined depth using the router assembly 32.

The base frame 26 is in the form of a substantially rectangular table having a top surface 36 supported above four vertical legs 38 having horizontal reinforcing beams 40 extending therebetween, including at the base of the frame 26. The configuration of the base frame 26 is not critical, provided it is robust enough to support the weight of the robotic arm even when the arm is at full extension away from the flame 26. The top surface 36, as well as the lowermost reinforcing beams 40 on the left and right hand sides of the robotic arm 30, extend forwardly from the frame 26 in the same direction as that of the robotic arm 30 to facilitate its support.

The height adjustable barrel mounting means 28 is in the form of a sub-frame 42 housed inside the base frame 26, the sub-frame 42 being capable of vertical movement relative to the base frame 26 through actuation of a pneumatic cylinder 44. Upward and downward movement is aided through the use of guide rollers 46 which slideably engage the inside surfaces of the legs 38 as shown in the drawings. A portion of the sub-frame 42 also extends forwardly from the base frame 26 in the direction as the robotic arm 30, to which a pair of spaced apart straps 48 for wrapping around and engaging the barrel 10 are attached. The straps 48 may be attached to the sub-frame 28 by any suitable means and may include a tensioning means 50 for tightening the straps 48. Those skilled in the art would realise that the barrel heads (not shown) of a used barrel 10 are to be firstly removed prior to being mounted within the straps 48.

It is to be understood that there may well be a plurality of straps used, or other alternate means of supporting the barrel 10. For example, a barrel floor support (not shown) extending out from the sub-frame 28 could be used. The benefit of the embodied configuration though is that the router assembly 32 can be moved vertically past the bottom end of the barrel 10 if need be, as there is no base structure below to prevent such movement. Furthermore, a floor structure would require further material, would increase the weight of the apparatus, and would possibly require a stronger pneumatic cylinder.

As mentioned, the sub-frame 28 is capable of vertical movement through actuation of a pneumatic cylinder 44. The pneumatic cylinder 44 is positioned centrally inside the base frame 26, and includes a ram 52 adapted to engage a portion of the sub-frame 28 such that when the ram 52 is in a retracted position inside the cylinder 44, the attached barrel 10 becomes grounded, and when the ram 52 is extended upwardly, the barrel 10 is at a height suitable for it to undergo scanning and cutting.

The robotic arm 30 comprises a base 54, an attached shoulder 56, a first arm member 58 pivotably linked to the shoulder 56, an elbow 60 pivotably linked to the opposed end of the first member 58, and a second arm member 62 rotatably linked to the elbow 60. The router assembly 32 is pivotably linked to the free end of the second arm member 62. Therefore, the robotic arm 30 is capable of pivoting in three ways, whereby each pivot axes extends transversely to the forward direction of the arm 30. The present invention is not intended to be limited to this particular robotic arm configuration, for example, the arm may be made to pivot in four or five ways, or along different axes, if desired.

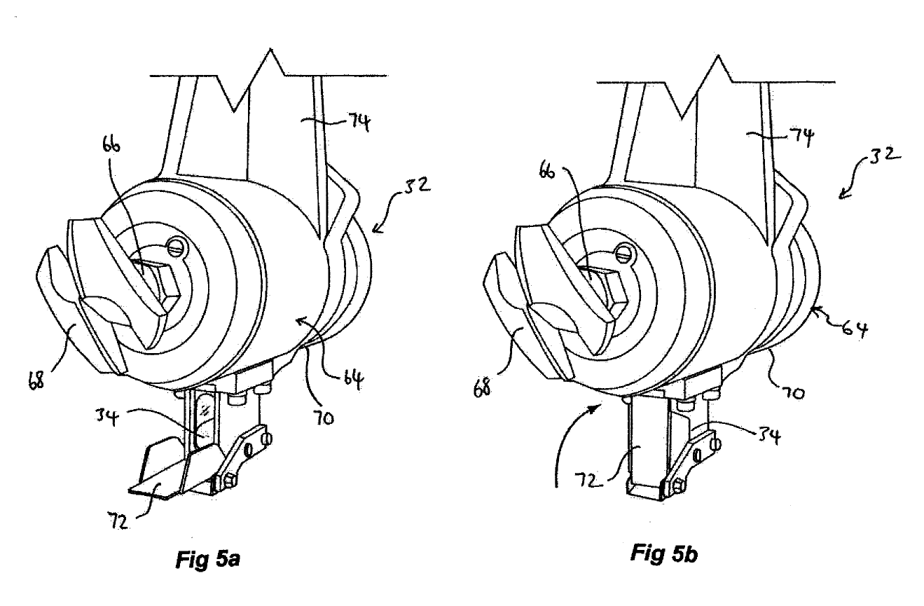

The router assembly 32 is shown clearly in FIGS. 5a and 5b. The assembly 32 includes an electric motor 64, a drive shaft 66 driven by the motor 64, and twin router blades 68 removably attached to the end of the drive shaft 66. As mentioned, a laser 34 is mounted beneath the motor housing 70 and points in the same direction as the twin blades 68. The laser 34 includes a shutter 72 that is pivotable from the open position shown in FIG. 5a, to the closed position shown in FIG. 5b. Movement of the shutter 72 is controlled so that it opens during scanning of the internal surface 14 of the barrel 10, and closed at all other times. The motor housing 70 is suspended from a bracket 74 pivotably linked to the second arm member 62 as described above.

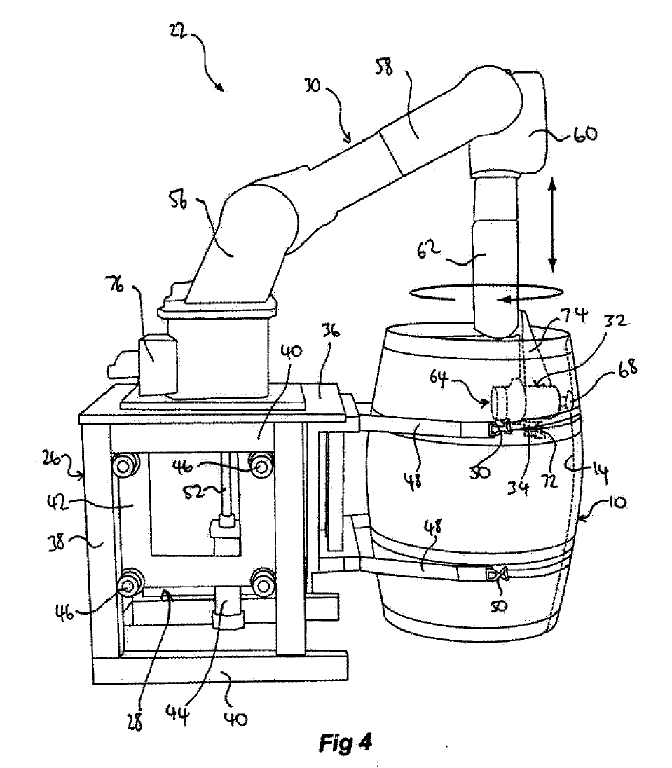

When the robotic arm 30 is not in use, the first member 58 extends substantially upwardly and outwardly with respect to the base frame 26, and the second member 62 extends downwardly and outwardly. FIG. 3 and FIG. 4 illustrate the robotic arm 30 when in use. It can be seen that in the in-use position, the first arm member 58 is more extended because it has been pivoted downwardly, as has the second member 62 which now extends inwardly slightly to ensure the router assembly 32 is positioned centrally inside the barrel 10, and the router blades 68 and laser 34 are aligned substantially horizontally. As will become apparent though, the router assembly 32 and laser 24 are pivoted to account for the barrel pitch and are aligned horizontally only when moving past the mid-section of the barrel 10.

The way in which the robotic arm 30 operates will not be described in great detail as this should be known to those skilled in the art. In a preferred embodiment, the joints are controlled pneumatically. At the base 54 of the arm 30 is a control box 76 which is connected to an external computing device (not shown). The computing device could alternatively be mounted within the base 54 of the arm 30 as shown in FIG. 2. The computing device is adapted to include software into which different scanning and cutting parameters may be input by an operator, such data being transmitted to the control box 76 to operate the pneumatic joints of the robotic arm 30 accordingly. The control box 76, computing device, and associated software are also used to control movement of the pneumatic cylinder 44, and the laser shutter 72.

The internal surface of the barrel 10 is therefore adapted to be scanned so that its internal dimensions are recorded, and then material is to be removed to a depth relative to the scanned dimensions. Those skilled in the art would realise that if a pro-scan of the surface did not take place, movement of the router would be based on a prediction of the internal dimensions and an inaccurate cut would result. By firstly scanning the surface, it can be shaved to a uniform depth across the entire inside surface of the barrel. The process ensures that the same amount of wood is removed at every point along the barrel surface, resulting in a barrel which has substantially the same internal relative dimensions to that of the original barrel, ready for crozing, toasting and re-use.

As shown in FIG. 3, the router assembly 32 is moved into the centre of the barrel. Then, using upward and downward strokes, the laser 34 is able to map the dimensions of the internal surface 14. Once the router assembly 32 has completed one downward stroke, the second arm 62 is rotated by a predetermined angle corresponding approximately with the radial extent of the scan on the internal surface 14, and then an upward stroke is commenced. This is continued until the second arm 62 has rotated 360 degrees and the entire internal surface 14 scanned. This data is recorded and transmitted to the computing device, and is processed together with data which is input by the operator, to produce cutting data which is subsequently transmitted to the control box 76. The cutting data defines the required movements of the robotic arm to shave the inside surface 14 of the barrel 10.

FIG. 4 illustrates the router assembly in use. As with the scanning process, the shaving process involves vertical strokes along the internal surface 14, until the second arm 62 has rotated 360 degrees to complete the cut.

It is to be understood that any appropriate sequence can be set up by an operator. For example, both the scan and cut may be achieved using any number of vertical passes rather than just one. Whilst some may prefer that the shave take place in two passes whereby half the material is removed in a first downward stroke, for example, and the remaining depth of material is removed in a second upward stroke it is envisaged that the shave will be done in a single complete cut. The present invention is not intended to be limited to any particular start angle, stop angle, pitch, or cut depth as these parameters are all variable and may be adjusted to suit different barrels.

The scan parameters which may be input by an operator are therefore as follows:
Start Angle (0-359 degrees)—this is the initial angle which is typically fit set to zero, but may be set at any required angle. For example if a barrel shaving process is started and stopped at a specific angle, then it can be recommenced at that start angle at a later time.
Stop Angle (0-359 degrees)—this is the angle by which the second arm member 62 and hence the router assembly 32 and laser 34 are rotated, following each vertical scan. For example, if the start angle is set to 0 degrees and the stop angle is set to 12 degrees, the laser 34 will perform a first vertical scan and then rotate about its axis by 12 degrees before commencing a second vertical scan, and so on. At this setting, the router assembly will perform thirty vertical scans per barrel.
Pitch (1-36 degrees)—this parameter accounts for the curve of the internal surface, and for a standard wine barrel is typically set to 10 degrees whereby when the router assembly is at the top of the barrel it is angled upwardly by 10 degrees, when lowered to the middle of the barrel is aligned horizontally at 0 degrees, and when lowered to the bottom of the barrel is angled 10 degrees downwardly. Alteration of this angle is achieved by way of controlled pivot of the bracket 74 relative to the second arm member 62.

Similarly, the variable cutting parameters are as follows:
Start Angle (0-359 degrees)—This is as per the scan start angle and is typically first set to 0 degrees.
Stop Angle (0-359 degrees)—This angle is determined by the width of the shave resulting from contact between the router blades and the surface. In a typical set up, an angle of 10 degrees is input into the software.
Pitch (1-36 degrees)—A pitch angle of approximately 5 degrees is typically used here for a standard wine barrel.
Cut depth pass 1 (mm)—As mentioned the router assembly can perform one or more passes on the internal surface during the cutting process. Therefore in order to shave 8 mm off the surface, the pass 1 cut depth will be set to −4 mm.
Cut depth pass 2 (mm)—If 8 mm is to be shaved off and 4 mm has already been shaved in the first pass, then −8 mm should be input here.

The skilled addressee would realise the benefit of using such a shaving apparatus in the portable reconditioning system of the present invention. Conventional shaving methods typically involve routing the internal surface by hand, but this technique is problematic in that it is a very slow process, it is not easily controllable, the quality of the wood is often adversely affected, and there is no way of ensuring that the surface will be shaved to the same depth across the entire surface. Therefore, the resultant internal dimensions of the barrel are not reflective, relatively, of the original barrel surface.

In first scanning the internal dimensions, and then applying a controlled shave across the internal surface as a function of the scanned dimensions, an extremely accurate cut can be performed. The robotic arm 30 of the present invention can move at approximately 1 metre/second, which means the internal surface of one barrel can be shaved within a time frame of 15-30 minutes. This is optimum for mobile reconditioning where time is of the essence. Further, operation of the apparatus can be modified to suit particular barrels in that parameters such as the scan/cut start and stop angles, the pitch, and the cut depth are variable, and can be input into the system.

The computing device can also be used to save data relating to such things as the amount of material removed from the barrel, the date and time a particular barrel was shaved, and the physical state of the barrel including how many more times the barrel may be reconditioned, if any. Such data may be uploadable to a central database located at a cooperage or other location. This same computing device could also be linked to the toasting apparatus 24 described below.

Once the inside surface of the barrel 10 has been shaved, it is ready to be toasted first and then re-crozed. However that is not to say that it may not be re-crozed first and then toasted.

The skilled addressee would realise that the croze line of the original barrel for accommodating the barrel head is positioned too high following the shaving process, and a new croze is required. In a preferred embodiment, a portable crozing apparatus 80 is used. Although not shown in the system of FIG. 2, the crozing apparatus 80 is intended to form part of the barrel reconditioning system 16 of the present invention.

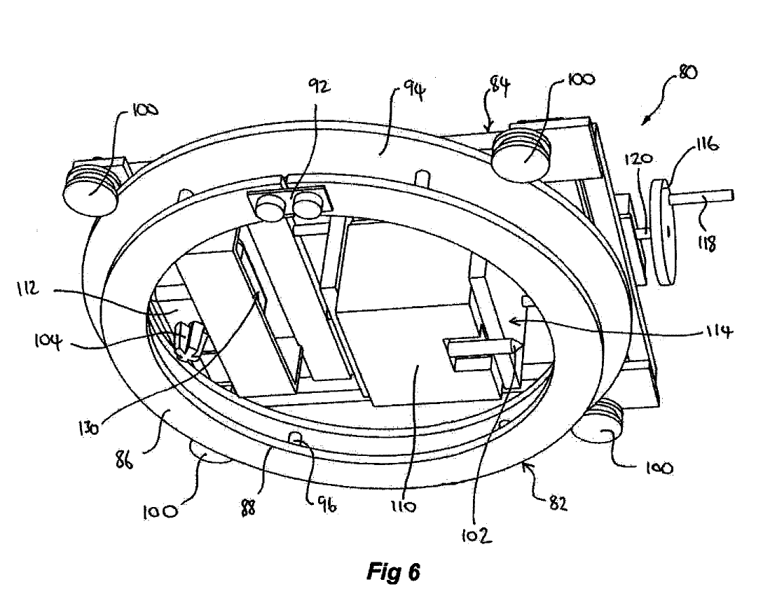

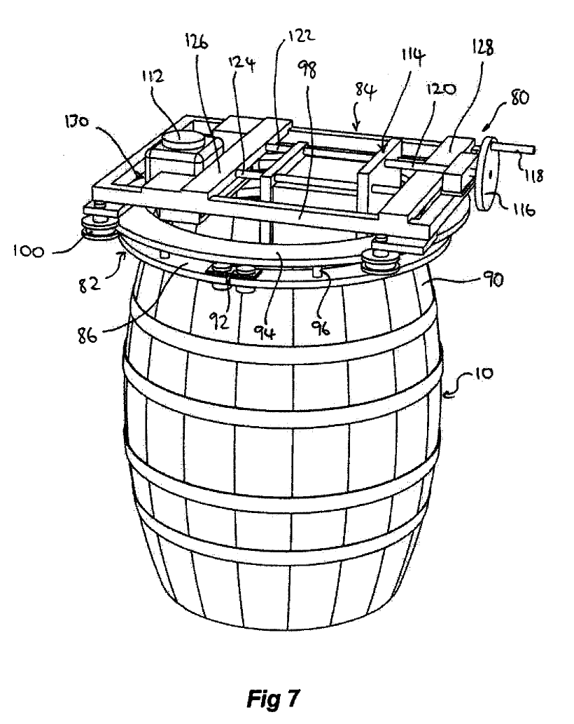

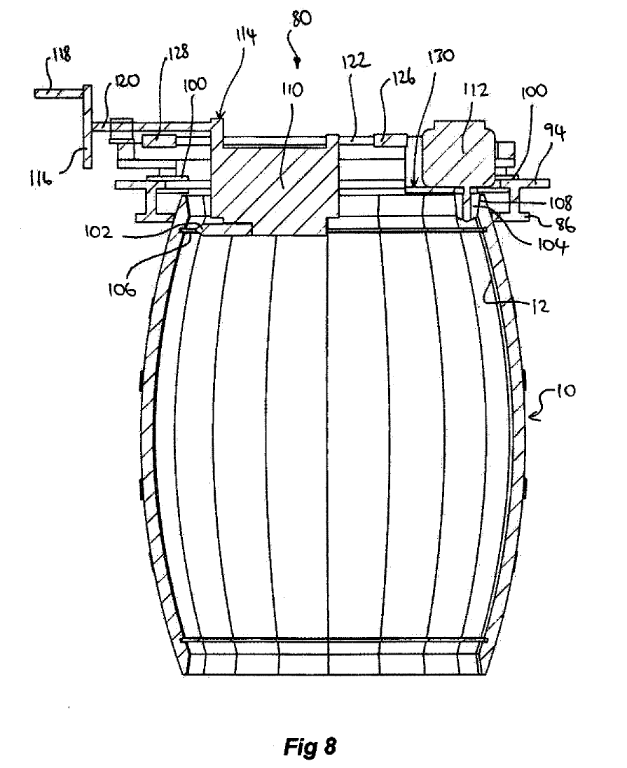

The portable crozer 80 is shown in FIG. 6. The crozer 80 includes a mounting assembly 82 and a cutting assembly 84 rotatably supported thereabove. The mounting assembly 82 includes an annular clamp 86 adapted to rest horizontally on the upper end of the upright barrel 10, as shown clearly in FIG. 7 and FIG. 8, whereby an inner edge 88 of the clamp 68 abuts with the outer curved surface 90 of the barrel 10. The clamp 86 includes adjustment means 92 to accommodate barrels of different diameter. It is to be understood that the mounting assembly 82 could be designed and configured differently, its important function being solely to secure the cutting assembly 84 in place on top of the barrel 10 ready for use.

The mounting assembly 82 further includes an annular guide 94 disposed a short distance above the annular clamp 86 by support rods 96, the guide 94 being of a larger diameter to that of the clamp 86. The diameter of the clamp 86 should be adjusted so that the guide 94 sits just above the top of the barrel as shown in FIG. 7 and FIG. 8. This ensures the cutting assembly 84 is at correct alignment inside the barrel 10 to perform the cutting operations, as described below.

The cutting assembly 84 is mounted to a substantially rectangular frame 98 having four rollers 100 suspended from the frame 98 in a radially disposed arrangement, to slideably engage the annular guide 94. Those skilled in the art would realise that such a configuration allows for rotational motion of the frame 98 and hence the cutting assembly 84, relative to the mounting assembly 82 which remains fixed to the barrel 10. Means to ensure that the clamp 86 does not move during operation of the cutting assembly could also be used.

At least one roller 100 could be electrically driven, in which case rotation of the frame 98 can be electrically controllable. For example, an associated switch (not shown) could be mounted to the frame 98 which when pressed activates rotational movement thereof. In such circumstances, it is envisaged that there would also be safety measures installed, for example, emergency stop switches and the like. In the embodiment shown however, the frame is manually rotatable preferably using handle bars (not shown) mounted to the frame 98.

The cutting assembly 84 comprises two separate cutting means 102 and 104, the first being an outwardly extending pointed blade 102 which when brought into contact with the inside surface 12 of the barrel 10 forms a croze 106 therealong, and the second being a downwardly extending router 104 adapted to create a bevelled edge 108 above the croze 106. The pointed blade 102 is conical in shape and terminates in a contact point, while the router 104 also terminates in a point but includes diagonal contact edges, as clearly shown in FIG. 8. Those skilled in the art would realise that each croze 106 and bevel 108 is to extend around the entire inside surface of the barrel 10, and this is achieved by rotating the frame 98 around the circular guide 94 through one or more revolutions. Each cutting means 102 and 104 is driven by a separate power source, in this embodiment being respective electric motors 11o and 112.

The cutting operations are made sequentially, that is, blade 102 is adapted to be used in a first pass to create the croze 106, and blade 104 is adapted to be subsequently used in a second pass to create the bevelled edge 108. The skilled addressee would realise that the cutting blades therefore need to be moveable between working and non-working positions relative to the inside surface 12.

The pointed blade 102 and its associated motor 110 are supported within a sub-frame 114, horizontally moveable by rotation of a spindle 116 using handle 118. This is achieved by way of threaded engagement between a shaft 120 associated with the spindle 116, and the sub-frame 114. More particularly, clockwise rotation of the spindle 116 moves the pointed blade 102 outwardly, closer to the inside surface 12 of the barrel 10, and anticlockwise rotation moves the pointed blade 102 inwardly, away from the inside surface 12. In an alternate configuration, clockwise rotation of the spindle 116 could move the blade 102 inwardly, and anticlockwise rotation could move the blade 102 outwardly.

Horizontal movement of the sub-frame 114 is aided by two guide shafts 122 and 124 which extend between cross members 126 and 128 associated with frame 98. The sub-frame 114 slideably engages the guide shafts 122 and 124 during movement caused by rotation of the spindle 116. It is to be understood that the spindle may have associated therewith visual indicia which indicates the position of the sub-frame 114 relative to a start position. For example, if a groove of say 5 mm is required, one could rotate the spindle 116 until such a reading is displayed on the visual indicia, and the blade will be in a position to form a 5 mm croze.

Although not shown, the sub-frame 114 and hence the pointed blade 102 is also adapted to be vertically moveable with respect to the mounting assembly 82. This could be achieved by any known adjustment means, for example, by way of rotational threaded engagement between a further spindle (not shown) and the sub-frame 114. A further adjustment means could be by way of engagement between a biased locking member and any one of a plurality of vertically disposed locking grooves (not shown) located on the sub-frame 114, each groove specifying a predetermined height. Vertical and horizontal movement of the sub-frame 114 could equally well be electrically controlled.

The position of the router 104 is also adapted to be vertically and horizontally moveable. For example, although not shown, the threaded shaft 120 associated with the spindle 116 could extend to a sub-frame 130 which houses the router 104 and associated motor 112. A moveable clutch arrangement (not shown) could be used whereby when the clutch is in one position, rotation of the spindle 116 causes movement of sub-frame 114, and when in a second position, rotation of the spindle 116 causes movement of sub-frame 130. Again, other adjustment means could be used, for example, vertical and horizontal movement of sub-frame 130 could equally well be electrically controlled.

Those skilled in the art would realise that following shaving and re-crozing of a used barrel, it would in fact hold approximately the same volume of liquid as a new barrel, given that even though material has been removed from the inside walls, the distance between crozes has been shortened.

The benefits of the portable crozer 80 in the barrel reconditioning system 16 of the present invention should be obvious. The crozer 80 is adapted to be mounted above the barrel after the shaving process for firstly creating a croze along an inside surface to accommodate a barrel head, and secondly, for creating a bevelled top edge. The croze is formed a short distance below the existing croze, and a new bevelled edge is formed to compensate for the lowered barrel head position. Conventional crozers are not portable which means they are not able to be used in portable systems such as these. The time taken for each croze is significant, and they are generally in the form of bulky, expensive machinery.

The step in the reconditioning process of toasting generally occurs before re-crozing and, once again, the portable reconditioning system of the present invention requires the use of a quick and effective toasting apparatus and method. An infrared toasting apparatus 24 is embodied herein, however, the present invention is not intended to be limited to this apparatus and method.

As mentioned, toasting may be performed inside the truck carriage 18 whereby particle/odour extraction ducts 132 lining the ceiling of the carriage are used to extract any air contaminants, if any, resulting from the toasting and shaving process. Generally there is however very little if no smoke at all.

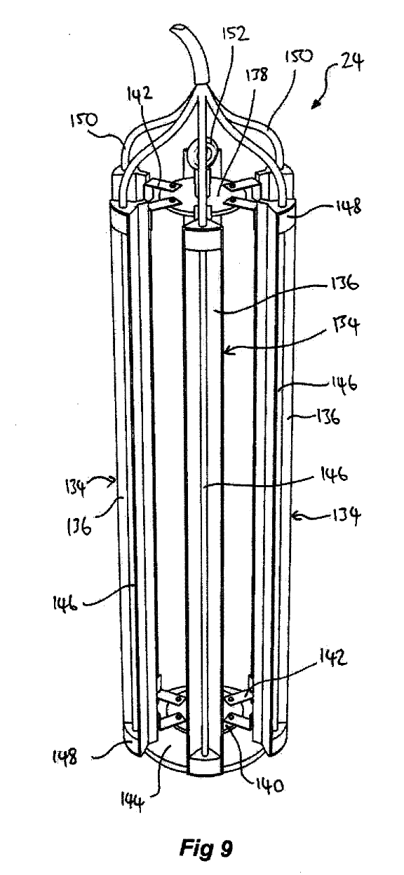

The apparatus 24 is shown in FIGS. 9-11 and includes six radially disposed electric infrared heaters 134 which are configured to rotatably oscillate inside the barrel 10 and thereby heat the inside surface 12 evenly. Each heater 134 is adapted to oscillate by an angle according to their radial separation. For example, in the embodiment shown, the apparatus 10 includes six heaters 134 which oscillate by approximately sixty degrees, that is, the heaters rotate clockwise by sixty degrees, then anticlockwise by sixty degrees, and this motion is repeated throughout the duration of toasting.

Each heater 134 includes a frame 136 mounted vertically between upper and lower circular plates 138 and 140 respectively, using perpendicular brackets 142. The lower plate 140 is rotatably supported above a circular base plate 144 enabling rotational motion of the heaters 134 in a carousel-type manner. Each frame 136 includes a substantially V-shaped cross section and houses longitudinal ends of infrared heating elements 146 within end portions 148 thereof. The perpendicular brackets 142 are fixed to the end portions 148.

Extending upwardly from each end portion 148 is an electric chord 150 for delivering electrical power to each heating element 146. Although not shown, the chords 150 lead to an external power supply, such as mains power. In a preferred embodiment, there is a control means (not shown) associated with the heaters 134 so that a user can control the amount of power delivered thereto. Therefore, the intensity of each heater 134 is adjustable.

In a typical barrel reconditioning process, toasting entails bringing the temperature of the inside surface of the barrel up to approximately 170-184 degrees Celcius, and maintaining the wood at that temperature for some 5-6 minutes. In being able to control the power delivered to each heater, a user is offered greater control over this process.

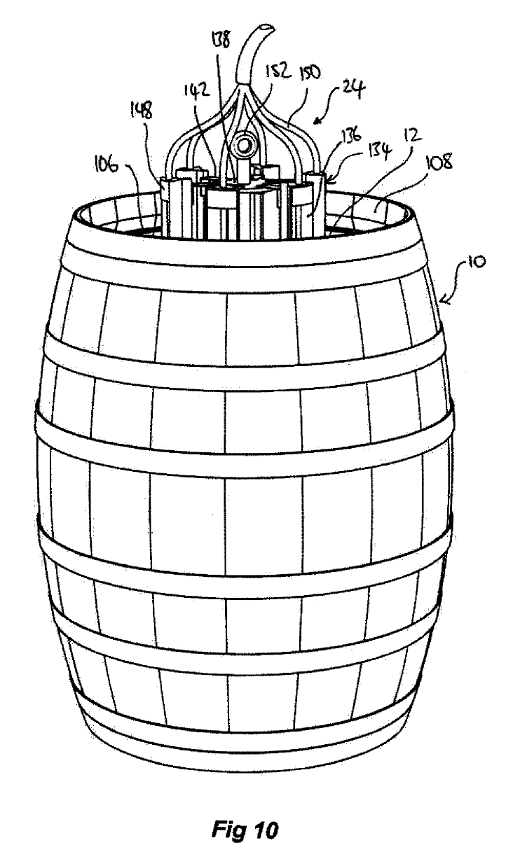

The apparatus 10 is adapted to be lowered inside the barrel 10 into the position illustrated in FIG. 10 so that the base plate 144 sits on the ground and the heaters 134 are positioned in a vertical configuration. A line extending through co-axial centre points of each plate 138 and 140 defines a central vertical axis of the apparatus 24, and each frame 136 is configured to direct heat outwardly from this axis towards the inside surface 12 for toasting. The barrel heads are typically pre-toasted.

The V-shape cross section of each heater frame 136 ensures that heat is confined to only a predetermined radial portion of the inside surface 12, as well as to the vertical height of the barrel (the length of the heating element is approximately the same as the height of the barrel). In a preferred embodiment, the inside surface of each frame 136 includes reflective plates (not shown) for increasing the intensity of heat emanating from the respective infrared heating elements 146 so that less power is required.

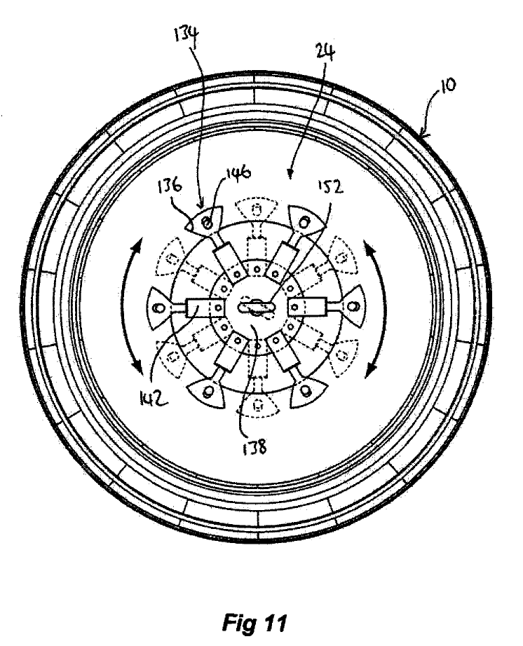

As mentioned, each heater 134 undergoes oscillatory rotation inside the barrel 10 by approximately the same angle as their radial separation. It is this action, together with the controlled portioning and temperature of heat, which ensure uniform heating across the entire surface. Rotation may be achieved using any suitable driving means. In one embodiment a circular hook 152 is fixed above the upper circular plate 138 and the driving means is preferably capable of engaging the hook 152, and rotating it clockwise a predetermined angle, then anticlockwise a predetermined angle, and so on. This motion is clearly illustrated in FIG. 11. However, the preferred embodiment is to pneumatically drive the bottom plate 144.

In a preferred embodiment, a pneumatic system using compressed air is used to rotate the heaters 134. For the purpose of brevity, this equipment is not shown in the drawings or described in any detail as it is considered well known to the skilled addressee. A control means would also naturally be associated with the pneumatic rotating means to allow for variation in stop and start angles of rotation, and for different speeds of rotation. All of these variables allow for greater toasting control and this is important because toasting techniques are typically cooper specific. The power is controlled by a controller to deliver a predetermined heat fitting a toast profile.

Although not shown, lowering and raising of the toasting apparatus 24 inside and out of the barrels 10 could be achieved using an electric lift, or the like. Further, the system 16 could well include a production line type arrangement wherein barrels which have been toasted and crozed are placed on a conveyor belt ready for toasting. In such circumstances, a plurality of barrels could be toasted in a virtually automated process. Although not shown, means to raise the barrel a short distance off the ground could also be used if required.

The portable reconditioning system 16 embodied herein therefore provides a number of advantages in respect of barrel toasting.

Uniformity is achieved because of the configuration of the heaters 134. The fact that they confine heat to a predetermined radial portion of the inside surface 12, and are rotatably oscillated, ensures an even spread of heat which prevents both blistering and under-toasting.

Repeatability is possible because the intensity of the heaters, the temperature as well as the heating time is controllable, which means that once a particular type of barrel has been toasted once, the same settings can be used again for a similar type of barrel. For example, a new barrel may require different toasting settings to a used barrel whose inside surface has just been shaved during reconditioning.

The toasting apparatus 24 is also suited to the portable system of the present invention because it is not an apparatus to which a barrel must be brought, but is rather a portable apparatus which can simply be lowered inside a barrel ready for use.

It is to be understood that the use of infrared heating elements is by way of example only, and that other controllable heat sources could equally well be used. Furthermore, other equipment for aiding a cooper in toasting the barrel could well be used, such as heat sensors positioned to measure the temperature inside and outside the barrel.

The present applicant is also the owner of Australian patent application no. 2006202071 relating to the production of barrel staves for new barrel manufacture. The reconditioning system disclosed herein is adapted for particular use on barrels manufactured using the applicant's own barrel stave manufacturing process which have since been used and now require reconditioning.

As mentioned, the computing device associated with the belt driven arm 30 is also preferably linked to the operation of the toasting apparatus 24. If the barrels were originally manufactured using apparatus and methods disclosed in the abovementioned application, then many barrel parameters will already be stored in a central database accessible by the computing device. Thus, such information could potentially be obtained via an internet connection or the like. The skilled addressee would realise the potential benefits in being able to access various sets of data from a remote site relating to barrels made for individual winemaking facilities.

Therefore when a truck or the like which carries the mobile shaving, crozing and toasting system 16 arrives at a vineyard or winemaking facility, information relating to the barrels can either be input manually or obtained through modern connection or other suitable means to a central database located at the cooperage. Such information can be used in the shaving process and would obviously result in a much more quick and efficient reconditioning process.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. A mobile system for reconditioning used barrels, said system including:
a means of shaving a predetermined amount of material from an internal surface of the used barrel to form a new inside surface;
a means of crozing at least one of said barrel ends;
a means of toasting said new inside surface; and
a vehicle for moving said shaving, crozing and toasting means to a desired location.

2. A mobile system for reconditioning used barrels as in claim 1 wherein said means of shaving the internal surface of the barrel includes a scanning means adapted to scan the internal dimensions of the barrel, and a cutting means adapted to shave the internal surface of the barrel to a predetermined depth relative to the scanned internal dimensions.

3. A mobile system for reconditioning used barrels as in claim 2 wherein said scanning means is adapted to vertically traverse the inside surface of the barrel to thereby scan a portion thereof with each pass.

4. A mobile system for reconditioning used barrels as in claim 2 wherein said cutting means is adapted to vertically traverse the inside surface of the barrel to thereby shave a portion thereof with each pass.

5. A mobile system for reconditioning used barrels as in claim 2 wherein movement of said scanning and cutting means relative to the inside surface of the barrel is controlled using a control means.

6. A mobile system for reconditioning used barrels as in claim 5 wherein said apparatus includes a computing device into which at least one movement parameter for the scanning means is input and subsequently processed to form a first set of movement data to be communicated to the control means.

7. A mobile system for reconditioning used barrels as in claim 6 wherein at least one movement parameter for the cutting means can also be input into said computing device and subsequently processed, together with dimensional data from the scanning means, to form a second set of movement data to be communicated to the control means.

8. A mobile system for reconditioning used barrels as in claim 2 wherein said cutting means is in the form of an electrically driven router mounted to the end of a robotic arm capable of a range of controlled movements inside the barrel.

9. A mobile system for reconditioning used barrels as in claim 8 wherein said scanning means is in the form of a laser scanner suspended beneath said electrically driven router and moveable therewith.

10. A mobile system for reconditioning used barrels as in claim 1 wherein said means of crozing at least one end of said barrel includes:
a mounting means for securing said crozer to said barrel end; and
at least a first cutting means rotatably associated with said mounting means, said cutting means configured to form a groove along an inside surface of said barrel adjacent the end, said groove adapted to accommodate a barrel head.

11. A mobile system for reconditioning used barrels as in claim 10 wherein said crozer includes a second cutting means rotatably associated with said mounting means, said second cutting means configured to form an inwardly extending bevel along an edge of the barrel end.

12. A mobile system for reconditioning used barrels as in claim 11 wherein said first and second cutting means are mounted to a supporting frame which rotatably engages the crozer mounting means, said first and second cutting means extending at least partially inside the barrel.

13. A mobile system for reconditioning used barrels as in claim 10 wherein the upright barrel includes a central vertical axis and said first cutting means is in the form of a pointed blade extending outwardly therefrom.

14. A mobile system for reconditioning used barrels as in claim 11 wherein said second cutting means is in the form of a downwardly extending router which when brought into contact with the inside edge of the barrel end, forms said bevel.

15. A mobile system for reconditioning used barrels as in claim 1 wherein said portable means of toasting said new inside surface includes a heating means configured to be insertable and removable from inside said barrel, and
a means of rotatably oscillating said heating means by a predetermined angle to facilitate uniform heating of said inside surface.

16. A mobile system for reconditioning used barrels as in claim 15 wherein said heating means is in the form of a plurality of elongate vertical heating elements radially disposed about a central vertical axis.

17. A mobile system for reconditioning used barrels as in claim 16 wherein the temperature of heat delivered by each heating unit is controllable.

18. A mobile system for reconditioning used barrels as in claim 16 wherein said apparatus includes six parallel heating elements separated by a radial angle of sixty degrees.

19. A mobile system for reconditioning used barrels as in claims 18 wherein each heating element is housed between end portions of a frame associated therewith.

20. A mobile system for reconditioning used barrels as in claim 19 wherein said frame is configured to direct heat from said heating element to a predetermined radial area of said barrel inside surface.

21. A mobile system for reconditioning used barrels as in claim 15 wherein said heating means is in the form of an infrared heater.

22. A mobile barrel reconditioning system including:
a shaving apparatus to uniformly shave a predetermined depth of material from an internal surface of said barrel and thereby form a new barrel internal surface;
a toasting apparatus to recondition said new internal surface ready for re-use; and
a vehicle for transporting said portable shaving apparatus and said toasting apparatus to a desired location.
